(19) United States
(12) Patent Application Publication
(10) Pub. No.: US 2005/0072316 A1
(43) Pub. Date: Apr. 7, 2005

(54) Transparent cooking wrap having reinforcing elements

(76) Inventors: Paul A. Tilman, Sherwood, WI (US); James E. Buchman, Hortonville, WI (US); Robert J. Speer, Upper Burrell, PA (US)

Correspondence Address: ECKERT SEAMANS CHERIN & MELLOTT, LLC;ALCOA TECHNICAL CENTER, 100 TECHNICAL DRIVE, ALCOA CENTER, PA, 15069-0001, US

(21) Appl. No.: 10/946,270

(22) Filed: Sep. 20, 2004

Related U.S. Application Data
(60) Provisional application No. 60/508,573, filed on Oct. 3, 2003.

(51) Int. Cl. A47J 27/00

(52) U.S. Cl. 99/446

(57) ABSTRACT

A continuous sheet of heat resistant material for use with cooking containers, such as bowls and pans. The sheet of material includes a transparent base layer and a plurality of reinforcing elements attached to the base layer. The reinforcing elements exhibit deadfold properties such that the reinforcing elements retain a desired condition. The sheet of base material is preferably a plastic material that is transparent and can withstand temperature extremes of −30° F. to at least 375° F. The reinforcing elements are preferably formed from materials that exhibit deadfold properties, such as aluminum foil or thermoplastic or thermoset materials that include the addition of calcium carbonate or other materials. The continuous strip of material is preferably wound into a roll and can be selectively severed by a user.

### CROSS REFERENCE TO RELATED APPLICATIONS

This application claims the benefit of U.S. Provisional Application Ser. No. 60/508,573, filed on Oct. 3, 2003, the disclosure of which is fully incorporated by reference herein.

### FIELD OF THE INVENTION

The present invention generally relates to a sheet of material that can be placed over a cooking container or around a food product such as meet or vegetables. More specifically, the present invention relates to a sheet of material that is at least partially transparent and includes structural reinforcing elements to provide deadfold properties such that the material can conform to a cooking container or food product.

### BACKGROUND OF THE INVENTION

Presently, food preparation requires the use of some type of cooking container, such as pots and pans, that holds the food being prepared when the food is cooked in an oven, over a stove or within a forced air cooker. Some foods, such as white and red meats, require continuous exposure to heat during the cooking cycle. In order to maintain the tenderness of the meat during the cooking cycle, a foil cover is typically used and placed over the cooking container or wrapped around the meat being cooked. An aluminum foil cover effectively shields the meat from direct exposure to heat but must be removed in order to observe and inspect the meat product. During removal of the aluminum foil cover, a significant risk of burn exists since the hot foil cover must be handled and rewrapped around the meat product.

A more desirable situation would be if the observer were able to view the cooking process through the foil when the foil was either wrapped around the meat or placed on the cooking container. One method of viewing through the foil is to create holes in the foil to provide a limited viewing area. However, holes in the foil significantly reduce the benefit of total covering of the food product. This presents an unsatisfactory condition and results in the unnecessary exposure of meat through the foil, which causes the meat to eventually dry out during the cooking process. An ideal situation would be where the foil was translucent such that the food could be viewed without disrupting the barrier of the foil.

Presently available sheets of plastic wrap cannot be used during many cooking cycles since the plastic wrap cannot withstand the temperatures used during a normal cooking cycle. If plastic materials that can withstand the heat generated during the cooking cycle are utilized, these materials do not include the required deadfold properties to retain their position over the cooking container.

Therefore, a need exists for a sheet of at least partially translucent or transparent material that retains its position over a cooking container or around a food product while allowing the user to view the progress of the cooking cycle without removing the sheet of material.

### SUMMARY OF THE INVENTION

The present invention relates to a sheet of material for use in cooking. The sheet of material includes a continuous base layer formed from a transparent plastic that can withstand cooking temperatures of at least 375° F. Preferably, the base layer of plastic film is formed from a material such as Nylon 6/6.

The continuous sheet of base layer is coupled to a plurality of reinforcing elements. Each of the reinforcing elements is attached to the sheet of base material. The reinforcing elements exhibit deadfold properties such that the reinforcing elements retain a bent or folded position. Thus, the reinforcing elements, when combined with the translucent base material, allow the sheet of plastic film to retain its position along a cooking container, such as a bowl or pot.

In one embodiment of the invention, the reinforcing elements extend across the width of the sheet of plastic film from one lateral edge to the opposite lateral edge. The reinforcing elements are spaced from each other along the length of the base layer and may be spaced in a repeating or random pattern. Preferably, the reinforcing elements are formed from a material that has sufficient deadfold properties, such as thermoplastic or thermoset materials that include the addition of calcium carbonate or other materials to provide the deadfold characteristics. Alternatively, the reinforcing elements could be metallic members, such as wire or thin strips or sheets of aluminum foil.

In a first alternate embodiment, the sheet of plastic film includes an upper base layer and a bottom base layer of translucent material that can withstand heat of at least 375° F. The reinforcing elements are sandwiched between the upper and lower base layers and are adhered in a spaced relationship to each other. The reinforcing elements can be separate elements or could be formed as a mesh layer.

In yet another alternate embodiment of the invention, the continuous sheet of material includes reinforcing elements that extend across the width of the plastic film in an angled configuration. In yet another embodiment of the invention, the continuous strip of material includes reinforcing elements that extend parallel to the lateral edges and are installed in a machine direction.

### BRIEF DESCRIPTION OF THE DRAWINGS

The drawings illustrate the best mode presently contemplated of carrying out the invention. In the drawings:

FIG. 1 is a perspective view of a roll of material constructed in accordance with the present invention and having transparent areas and reinforcing elements;

FIG. 2 is a section view taken along line 2-2 of FIG. 1;

FIG. 3 is a perspective view illustrating the sheet of material placed over a cooking container;

FIG. 4 is a section view similar to FIG. 2 showing an alternate embodiment of the invention;

FIG. 5 is a perspective view illustrating a second embodiment of the present invention;

FIG. 6 is a perspective view illustrating a third embodiment of the invention;

FIG. 7 is a perspective view illustrating the reinforcing elements aligned in a mesh or grid configuration;

FIG. 8 is a perspective view of the roll of material including strips of reinforcing elements; and

FIG. 9 is a sectioned view taken along line 9-9 of the FIG. 8.

### DETAILED DESCRIPTION OF PREFERRED EMBODIMENTS

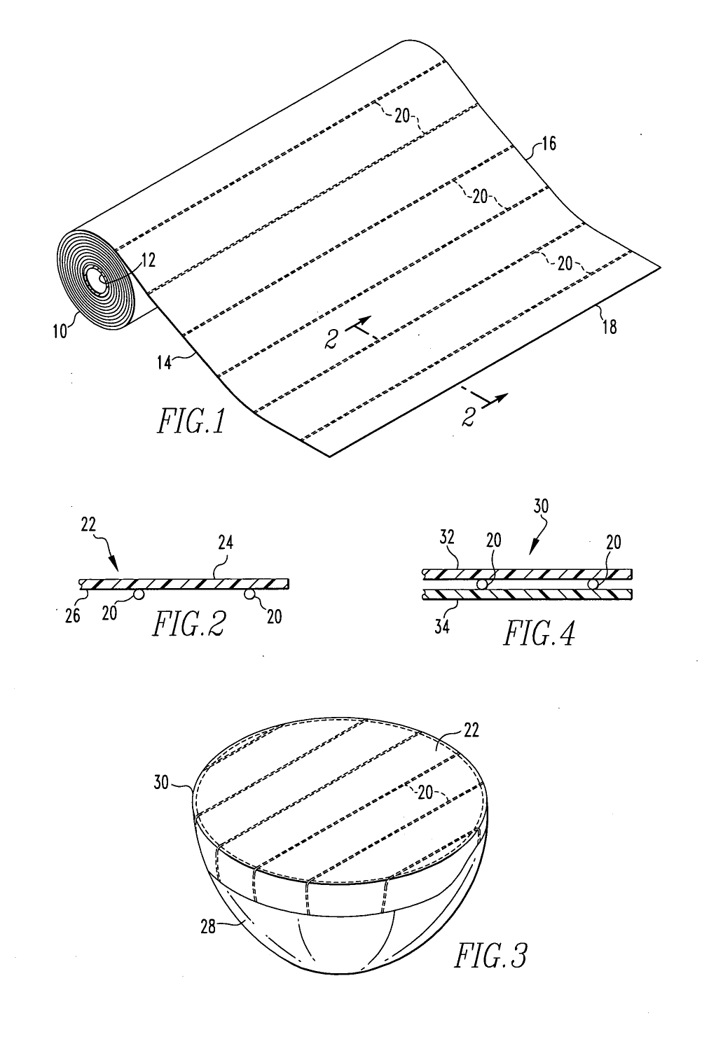

Referring first to FIG. 1, thereshown is a roll 10 of material in accordance with the present invention. As illustrated in FIG. 1, the roll 10 is wound around a core 12 and can be unwound in a conventional manner for use by a user. The roll 10 includes a continuous sheet of transparent film extending between a pair of spaced lateral edges 14, 16. The lateral edges 14, 16 define a transverse width for the roll 10. As illustrated in FIG. 1, the roll 10 includes a leading edge 18. The leading edge 18 is created by the user by tearing a section of the transparent film from the roll 10. Typically, the roll 10 is contained within a paperboard container having a cutting edge such that the user can select the desired length of film for a particular application.

As shown in FIG. 1, the film includes a plurality of reinforcing elements 20 spaced along the length of the film. In the embodiment of the invention shown in FIG. 1, each of the reinforcing elements 20 extends across the width of the film from the lateral edge 14 to the lateral edge 16. In the embodiment of the invention illustrated, the reinforcing elements 20 are spaced approximately one inch from each other, although other spacing is contemplated as being within the scope of the invention. The amount of space between the reinforcing elements 20 determines the areas in which the film can be separated from the roll in a transverse direction from the continuous roll 10.

Referring now to FIG. 2, the continuous sheet 22 is shown in a sectional view. As illustrated, the sheet includes a plastic base layer 24 and a plurality of reinforcing elements 20. In the embodiment of the invention illustrated, each of the reinforcing elements 20 is adhesively attached or heat bonded to the face surface 26 of the base layer 24. However, it is contemplated that the reinforcing elements 20 could be attached to the face surface 26 using many different types of attachment techniques while operating within the scope of the present invention.

In the embodiment of the invention illustrated in FIG. 2, the base layer 24 is formed from a continuous sheet of clear or translucent material, such as by example Nylon 6/6 that has heat resistant properties in the order of 375° F. The Nylon 6/6 that is used in the preferred embodiment of the invention can withstand normal cooking temperatures and does not degrade during long exposures to heat in this range.

As can be understood, the base layer 24 is formed from a flexible material that has minimal deadfold characteristics. Thus, if only the base layer 24 were utilized, the base layer would not retain a folded condition when attached to a cooking container. In order to affix the base layer 24 to a glass bowl, the reinforcing elements 20 are attached to the base layer 24 in a spaced relationship as shown in FIG. 2.

In the preferred embodiment of the invention, the reinforcing elements 20 are formed from materials that exhibit deadfold characteristics such that the reinforcing elements will retain a bent condition when the film 22 is used with a cooking container, such as a bowl or pot.

In one embodiment of the invention, the reinforcing elements 20 could be formed from a metallic material such that the reinforcing elements 20 would retain a bent condition. For example, the reinforcing elements could be small gauge wire or thin strips of aluminum foil. Alternatively, the reinforcing elements 20 could be comprised of one or more elements of thermoplastic or thermoset material that include the addition of calcium carbonate or other materials in order to provide the folding characteristics required. In either event, the reinforcing elements exhibits deadfold properties such that the reinforcing elements retain their shape when folded by a user into a desired condition.

Referring now to FIG. 3, thereshown is a sheet of material 22 applied to a cooking container 28, such as a glass bowl. As illustrated, each of the reinforcing elements 20 is bent along the rim 30 of the bowl 28 and retains its bent condition. As shown in FIG. 3, the sheet of material 22 is thus retained along the upper rim 30 of the bowl 28 such that the contents of the bowl 28 are covered. As can be understood in FIG. 3, since the sheet of plastic film 22 is translucent, the user can monitor the progress of the cooking through the sheet 22 without removing the sheet from the bowl 28.

Referring now to FIG. 4, thereshown is an alternate configuration for the continuous sheet of film 30. In the embodiment shown in FIG. 4, the sheet of film 30 includes a first base layer 32 and a second base layer 34. Both the first base layer 32 and the second base layer 34 are formed from a sheet of clear or translucent material that has heat resistant properties in the order of 375° F. For example, both the upper layer 32 and the lower layer 34 could be formed from Nylon 6/6 or other similar material.

As illustrated in FIG. 4, the plurality of reinforcing elements 20 are sandwiched between the base layers 32, 34 and are preferably held in place by an adhesive or heat bonding. The sheet of plastic film 30 constructed in accordance with the embodiment shown in FIG. 4 exhibits the same properties as the first embodiment shown in FIGS. 2 and 3 and thus includes the required deadfold properties to be held in place along a cooking container.

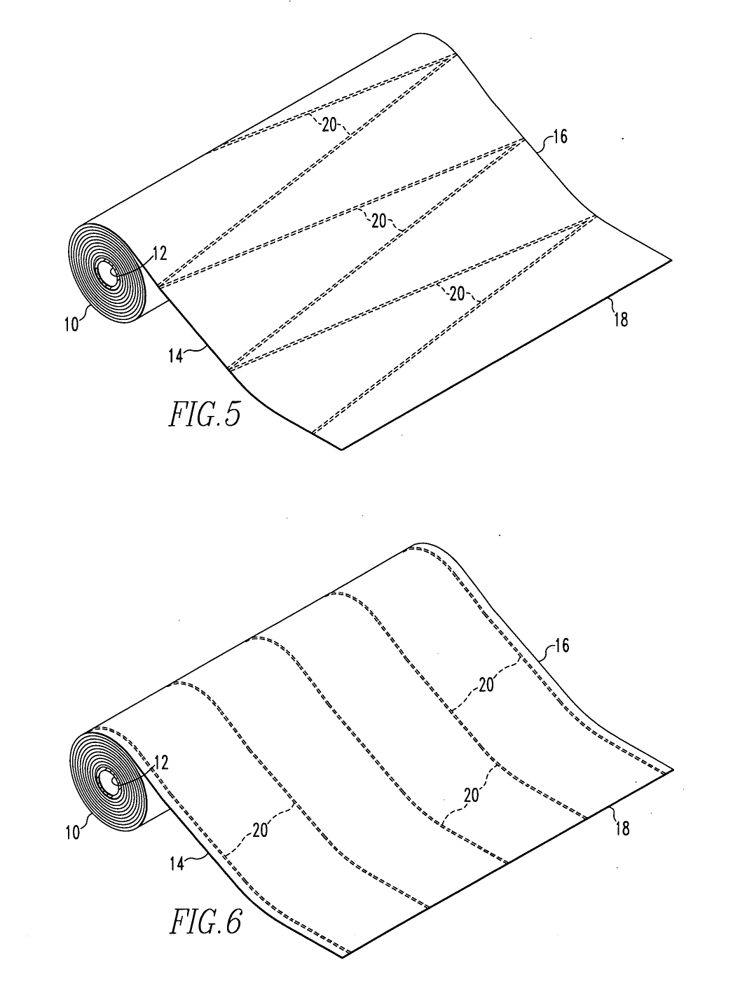

Referring now to FIG. 5, thereshown is an alternate configuration for the roll of material 10. In this embodiment, the reinforcing elements 20 extend at an angle relative to the leading edge 18 of the continuous sheet. Each reinforcing element 20 extends from the lateral edge 14 to the lateral edge 16. However, the reinforcing elements form an angled pattern along the continuous sheet of film.

Referring now to FIG. 6, thereshown is yet a third embodiment of the plastic film of the present invention. In the embodiment shown in FIG. 6, the reinforcing elements 20 each extend generally parallel to the lateral edges 14, 16 from the leading edge 18. In the embodiment shown in FIG. 6, each of the reinforcing elements are inserted into the plastic film in a machine direction. In the embodiment in FIG. 6, when a user desires to remove a piece of the plastic film from the roll 10, each of the reinforcing elements 20 is severed by a cutting edge formed on the container for the roll 10. The advantage of the embodiment shown in FIG. 6 is that during manufacture, the reinforcing elements 20 can be attached to the plastic film in a machine direction, which may aid in the processing speed.

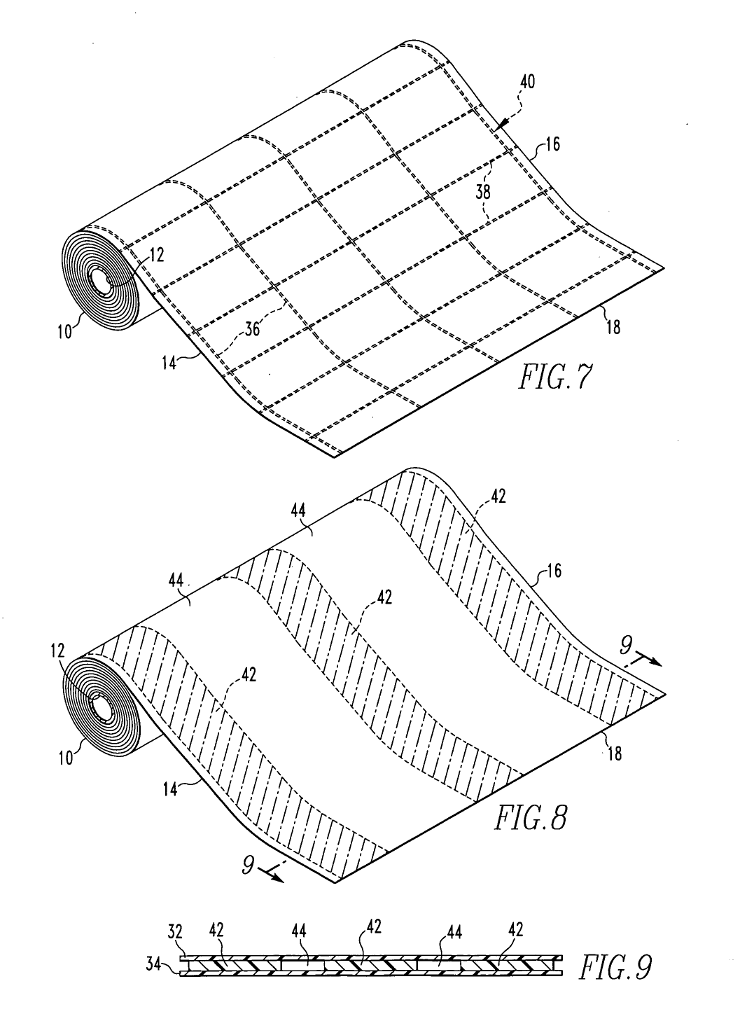

Referring now to FIG. 7, thereshown is yet a fourth embodiment of the film of the present invention. In the embodiment shown in FIG. 7, the reinforcing elements included within the roll of material define a grid-like pattern as illustrated. Specifically, the grid pattern is formed of a plurality of longitudinal reinforcing elements 36 and a plurality of transverse reinforcing elements 38. The transverse and longitudinal reinforcing elements 36, 38 could be separate elements or, alternatively, the grid itself could be formed from a continuous sheet of metallic material, such as aluminum foil. In an embodiment in which the reinforcing element are formed as a continuous grid from aluminum foil, the grid pattern could form one of numerous particular configurations. For example, it is contemplated by the inventors that the grid could have the rectangular format shown in FIG. 7, or could have a hexagonal pattern, a diamond pattern or any other similar pattern. The reinforcing elements that form the grid clearly provide the required deadfold properties as was described in detail above. The advantage of an integrally formed grid, as compared to a grid formed from separate elements, is that the grid can be placed more accurately on a sheet of plastic film as compared to a plurality of individual transverse and longitudinal elements.

Referring now to FIG. 8, thereshown is a fifth embodiment of the film of the present invention. In the embodiment shown in FIG. 8, the film includes several relatively wide strips 42 equally spaced along the width of the roll from the first edge 14 to the second edge 16. In an illustrative embodiment of the invention, each of the strips 42 can have a width of approximately two inches. Transparent areas 44 are positioned between the strips 42 to allow the user to view through the continuous strip of film. The strips 42 provide the required deadfold properties as described above.

Referring now to FIG. 6, each of the strips 42 is sandwiched between a first base layer 32 and a second base layer 34 as discussed previously. The strips 42 comprise a greater percentage of the width of the roll as compared to the embodiments discussed previously. In the preferred embodiment of the invention, each of the strips 42 is formed from aluminum foil, a material that is both inexpensive and has the required deadfold properties.

Although the present invention has been described as including reinforcing elements formed from various materials, it is important to note that the reinforcing elements should be formed of a material that exhibits deadfold properties. The reinforcing elements are provided to allow the sheet of plastic film to maintain its position along the cooking device. The specific materials used to create the retaining elements can be varied depending upon cost to manufacture and material handling issues.

Having described the presently preferred embodiments, it is to be understood that the invention may be otherwise embodied within the scope of the appended claims.

1. A heat resistant sheet of at least a partially transparent material comprising:
a continuous first base layer formed from a heat resistant transparent material exhibiting minimal deadfold properties; and
a plurality of reinforcing elements positioned along the base layer, each of the reinforcing elements being formed from a material having deadfold properties such that the sheet of material can retain a desired position.

2. The sheet material of claim 1 wherein each of the reinforcing elements extends across the continuous base layer from a first lateral edge to a second lateral edge.

3. The sheet material of claim 2 wherein the reinforcing elements are equally spaced along the length of the base material.

4. The sheet material of claim 1 wherein each of the reinforcing elements extends parallel to lateral edges of the continuous base layer.

5. The sheet material of claim 1 further comprising a lower second layer spaced from the first base layer, wherein each of the reinforcing elements are sandwiched between the second base layer and the first base layer.

6. The sheet material of claim 1 further comprising a plurality of venting areas formed in the base layer.

7. The sheet material of claim 1 wherein the plurality of reinforcing elements are joined to each other such that the plurality of reinforcing elements create a mesh-like layer, wherein the mesh-like layer is positioned along the base layer.

8. The sheet material of claim 7 wherein the mesh-like layer is formed from aluminum foil.

9. The sheet material of claim 7 wherein the mesh-like layer is positioned between a second base layer and the first base layer.
